(19) United States
(12) Patent Application Publication
(10) Pub. No.: US 2001/0027437 A1
(43) Pub. Date: Oct. 4, 2001

(54) Risk management and risk transfer conduit system

(76) Inventors: Wallace C. Turbeville, New York, NY (US); J. Scott Perry, New York, NY (US)

Correspondence Address: Peter D. Aufrichtig, Esq., AUFRICHTIG STEIN & AUFRICHTIG, P.C., 300 East 42nd Street, 5th Floor, New York, NY, 10017, US

(21) Appl. No.: 09/795,788

(22) Filed: Feb. 27, 2001

Related U.S. Application Data
(60) Provisional application No. 60/185,900, filed on Feb. 29, 2000.
(60) Provisional application No. 60/197,166, filed on Apr. 14, 2000.
(60) Provisional application No. 60/197,167, filed on Apr. 14, 2000.

(51) Int. Cl. G06F 17/60

(52) U.S. Cl. 705/38; 705/39; 705/40; 705/26

(57) ABSTRACT

A method for managing, on a pooled basis, the credit risk coverage of contract performance by contracting parties. An aggregate maximum credit risk coverage for all contracts by each contracting party is established. Pools are defined into which contracts from various contracting parties may be aggregated. A credit risk coverage limit is defined for each of the pools. When a contract is entered into the credit risk coverage associated with that contract for each contracting party is calculated and it is determined whether that credit risk coverage plus the risk coverage associated with all other existing contracts of that contracting party are within the maximum credit risk coverage for that contracting party. That determination is then used to decide whether to accept the contract in the pool. The invention is particularly suited to the use with products and services which are illiquid or difficult to inventory, such as electrical power, forestry products and chemical products. The invention is also directed to a delivery logistics system and receivables funding system.

### BACKGROUND OF THE INVENTION

The invention is generally directed to a method for managing, on a pooled basis, the credit risk coverage of contract performance by contracting parties. The system is particularly useful in connection with sale of products and services to allow sellers to, among other things, manage more efficiently the future utilization of their production capacity and buyers to manage their supply of industrial inputs dynamically. The method can support trading of products that are generally illiquid and difficult or impossible to inventory. The system can be accessible on an Internet-based platform as well as other platforms and creates liquid, tradeable, fully anonymous contract units which can be standardized for counter-party risk of physical delivery under established industry practices.

The invention is also directed to a logistics optimization system to minimize the total costs of shipping or transportation of products traded in the reduced risk trading system of the invention.

The invention is also directed to a receivables funding system in which a seller is able to receive payment at the time of the transaction even if delivery of the products are at a future date.

Traditionally, various products which were commonly available in standardized forms, quantities and qualities were marketed as commodities in which a buyer readily accepted the commodity in the standardized forms, quantities and qualities independent of the source or identity of the producer. The commodities could then be traded in a market or exchange. The exchange would impose rules on the underlying products themselves and on the form of the transaction. These rules controlled payment, location of payment, time and location of delivery of the commodity and dispute resolution procedures.

Two well known forms of exchanges are the stock exchanges(such as the New York Stock Exchange, American Stock Exchange and NASDAQ) and commodities exchanges (such as the New York Mercantile Exchange and New York Metals Exchange). The stock exchanges trade only in shares of stock of companies who pay for their stocks to be listed and traded on an exchange. In return, the companies are required to follow numerous rules imposed by the exchanges and other rules imposed by government regulators and statutes. For example, the NYSE rules require that member companies must issue financial reports in accordance with established and uniform accounting procedures. Similarly, there are rules for the settlement of trades by the seller producing the stock certificate or other indicia of the ownership of the agreed upon number of shares of the stock and by the purchaser in making payment to the seller. The regulations also provide methods of resolving disputes between sellers and purchasers and between exchange operating companies(brokerage companies) and their customers who use the operating companies to execute their purchase and sales.

Similarly, in the commodities markets there are rules relating to delivery, payment and dispute resolution. However, the delivery rules are necessarily more specialized as the commodities being traded and delivered are physically larger and more difficult to transport. Commodities such as gold, petroleum products, orange juice, pork bellies(bacon) and various other metals, agricultural products and raw and processed natural resources require specific rules relating to delivery, quality and specification establishment, testing and assurance.

Through the procedures in force companies, involved in the manufacture, growing, processing, use and sale of these commodities and companies whose products or services require these commodities as a component of their products or services, can use the exchange as a way to minimize price fluctuations in the supply or demand for their products by purchasing the right to purchase or sell product at a specified price at a specified date at a specified delivery point. In this way, for example, a coffee manufacturing company can purchase contracts for future delivery of coffee beans to assure itself of a steady supply of products at a known cost so that it can enter into long term supply contracts for its finished coffee products without being forced to absorb the market risk if the price of the raw material (coffee beans) rises sharply. Similarly, producers can sell their future crops to obtain payment to finance their farming and harvesting operations and protect against fluctuations of the market price. This type of exchange deals in contracts called futures contracts which are the right to buy or sell a commodity for a fixed price at a date in the future at a fixed delivery location.

Futures trade arrangements within the stock markets are called options and are a contract right to purchase or sell a block, generally 100 shares, at a strike price either by or on a certain date in the future. The option contract has a price associated with it based on the current price of the underlying stock, the strike price associated with the option contract and the expectation of the movement of the price of the underlying stock between the trade date and the date on which the option must be exercised.

Generally, in the commodities exchanges there is no provision for immediate trades, and all of the contracts are offered as futures contracts of varying lengths, generally associated with a particular month, such as December 2001 Gold or July 2001 Pork Bellies. The member firms of the exchanges, which make the markets execute the trades on behalf of their customers, provide services in handling the administrative aspects of the transaction and coordinating the transfer of funds between the buyer and seller, who often and generally don't know or care who the other party is.

One result of trading on traditional exchanges is that, because the rules governing the exchanges standardize the terms of the transactions, parties may trade on the exchange without knowing the identity of the other party(s) to the trade. This anonymity of counter-party is an important element of the exchange's ability to increase the liquidity of trading in a commodity and thus provide a generally lower and more stable price than would exist if all trades required a direct relationship between buyer and seller. If a market participant is indifferent to the identity of its counterparty, all participants are potential buyers and sellers and prices do not vary based on the credit quality of the participant.

Another aspect of the anonymity is the manner in which this allows different types of market participants to all function without disparate treatment. That is, those who i)expect or may be interested in either delivering or taking delivery of the actual physical commodity, ii) hedge against their business risks or iii) speculate or trade commodity contracts on the hope of profiting from the movement of the contract price, all operate according to the same rules without distinction. In this way, the anonymity of the exchange increases the liquidity of the market for the individual product.

While the commodities markets have been successful in improving liquidity and reliability of trading for the subject commodities, there are many more products which have not been traded on exchanges because of the nature of the products, the delivery problems, or other special factors. However, many of these industries (in particular electrical power, forestry products, specialized chemical products), have experienced severe price fluctuations resulting from the absence of liquidity in the marketplace and no reliable system other than direct bilateral agreement between producer and purchaser to establish forward supply planning. As a result, there is a need to establish a trading system and method which can facilitate liquidity and reliability for these products which are not sufficiently uniform enough to be traded as commodities on established exchanges. There is a need for a method of commoditizing products, such as energy, forest products and chemicals in such a way that allows uniform futures contracts to be traded. Such a system will promote market liquidity and price stability in the product market.

### SUMMARY OF THE INVENTION

The invention is generally directed to a method for managing, on a pooled basis, the credit risk coverage of contract performance by contracting parties. An aggregate maximum credit risk coverage for all contracts by each contracting party is established. Pools are defined into which contracts from various contracting parties may be aggregated. A credit risk coverage limit is defined for each of the pools. When a contract is entered into the credit risk coverage associated with that contract for each contracting party is calculated and it is determined whether that credit risk coverage plus the risk coverage associated with all other existing contracts of that contracting party are within the maximum credit risk coverage for that contracting party. That determination is then used to decide whether to accept the contract in the pool. The invention is particularly suited to the use with products and services which are illiquid or difficult to inventory, such as electrical power, forestry products and chemical products. The invention is also directed to a delivery logistics system and receivables funding system.

Accordingly, it is an object of the invention to provide an improved system for standardizing contracts for products and services to make their trading more like a commodity.

It is a further object of the invention to provide an improved logistics optimization system to minimize the total costs of shipping or transporting those products traded under the risk transfer conduit system based on contracts.

Still another object of the invention is to provide an improved business-to-business virtual market for trading of products not currently tradable as commodities.

Another object of the invention is to provide a system whereby market participant credit facility availability and exchange risk exposure is calculated to manage pooling and transfer of risk.

Still yet a further object of the invention is to provide a calculation of a product forward index using market sampling, market canvassing and liquidity factors.

Still another object of the invention is to generate hedging position data to identify and implement hedge positions which will optimize the value of the exchange's risk portfolio.

Yet still a further object of the invention is to provide a risk transfer conduit system to trade electricity contracts.

Yet still another object of the invention is to provide a risk transfer conduit system to trade forest products contracts.

Still other objects and advantages of the invention will, in part, be obvious and will, in part, be apparent from the specification.

The invention accordingly comprises the features of construction, combinations of elements, arrangements of parts, steps, procedures and methods of operation which will be exemplified in the constructions and processes as hereinafter set forth, and the scope of the invention will be indicated in the claims.

### BRIEF DESCRIPTION OF THE DRAWINGS

For a fuller understanding of the invention, reference is had to the following descriptions taken in connection with the accompanying drawings, in which:

FIG. 1 is an illustration of a computer system constructed in accordance with an embodiment of the present invention.

FIG. 2 is an illustration of a program for allocating risk in accordance with an embodiment of the present invention.

FIG. 3 is a graphical representation of a bilateral separately negotiated contract without aggregation of risk in accordance with the prior art;

FIG. 4 is a graphical representation of an electronic exchange structure with risk transfer;

FIG. 5 is a graphical representation of a transmission example in the electricity contract market constructed in accordance with a preferred embodiment of the invention;

FIG. 6 is a graphical representation of a portfolio based evaluation of portfolio risk and securitization of the credit risk through allocation of insurance and risk retention in accordance with a preferred embodiment of the invention;

FIG. 7 is a graphical representation of the transportation of forest products through a delivery node in Montreal, Quebec, Canada from buyers to sellers using a system of commoditization in accordance with the invention; and

FIG. 8 is a graphical representation of the transportation of forest products set for through a delivery node in Montreal, Quebec, Canada in accordance with the logistics optimization system in accordance with the invention which reduces transportation expenses.

### DETAILED DESCRIPTION OF THE PREFERRED EMBODIMENTS

The invention is generally directed to three unique financial systems to transfer credit risks from electronic and conventional exchanges and to enable the creation of a virtual market for business-to-business trading of products and services which have previously not been tradable on a commodity exchange. A risk transfer conduit system is at the core of the financial systems and creates the opportunity for the application of the other two systems, a logistics optimization system and a receivables funding system. The financial systems are appropriate for use in connection with existing and planned electronic, Internet and over-the-counter marketplaces, as well as traditional exchanges.

The risk transfer conduit system is used to reduce or eliminate counter-party risk in contracts which may be traded in over-the-counter transactions, on electronic exchange platforms or on conventional exchanges. Counter-party risk is defined as the risk to a party from the non-performance of the party to a contract for the purchase and sale of a product. For example, the counter-party risk to a seller is the risk that the buyer does not take and/or pay for the goods or services in accordance with the contracted conditions. The counter-party risk for the buyer is the risk that the seller will not deliver the required goods or services in accordance with the contracted conditions, such as the required time and location.

The logistics optimization system was developed to minimize the total costs of shipping or transportation of those products traded under the risk transfer conduit system. This is done, as described below, by evaluating a portfolio of contract trades and then optimizing the delivery costs by pairing up the buyers and sellers, whose identities are not known to each other, in a fashion which reduces the overall shipping costs for all deliveries.

The receivables funding system allows sellers of products traded under the risk transfer conduit system to receive immediate payment for the sale of products for delivery at a future date. This is enabled by the financial planning and securitization of the process established by the risk transfer conduit system.

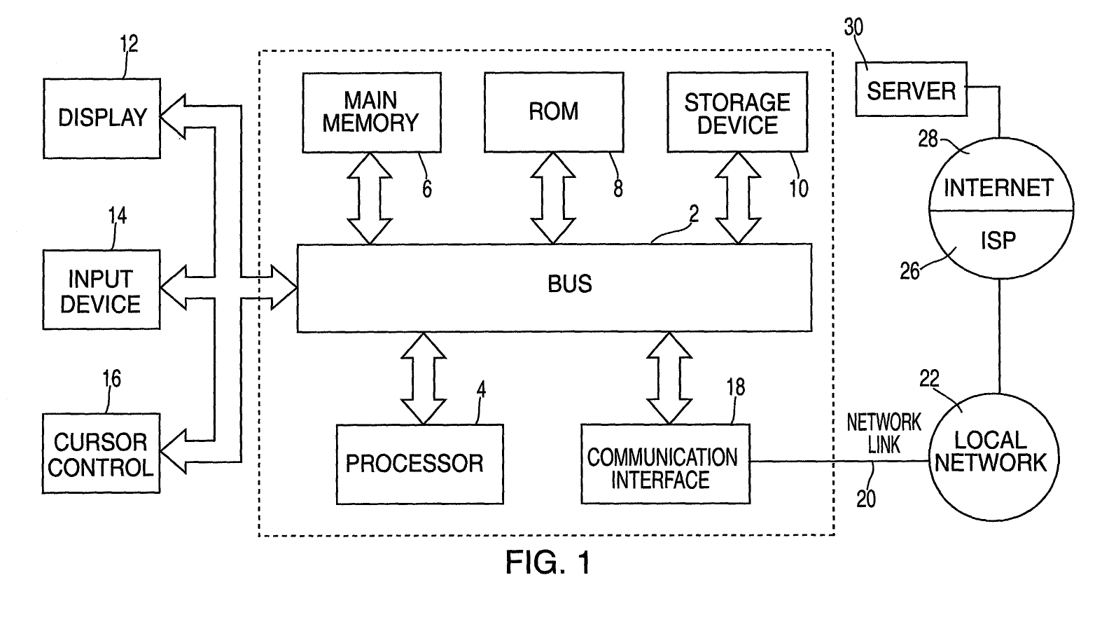

Reference is made to FIG. 1 which illustrates a computer system for carrying out the method of the present invention. The computer system includes a bus 2 for communicating information coupled to a central processing unit 4, main memory 6, read only memory (ROM) 8, digital storage 10 and communication interface 18. The bus 2 is also coupled to a display 12, input device (e.g., keyboard) 14 and cursor control 16. The computer system operates through the execution of instructions by the processor 4 which are retrieved from main memory 6, ROM 8 or digital storage 10. Generally, main memory 6 stores a program of instructions which the processor 4 executes in combination with input data retrieved from ROM 8 or digital storage 10. The computer system may also receive data (or other instructions) from other computer systems which transmit such information to the computer system over the communication interface 18. The communication interface 18 is generally coupled to a local network 22 which is coupled to an Internet service provider (ISP) 26 that connects to the Internet 28 and eventually to other computer systems through server 30.

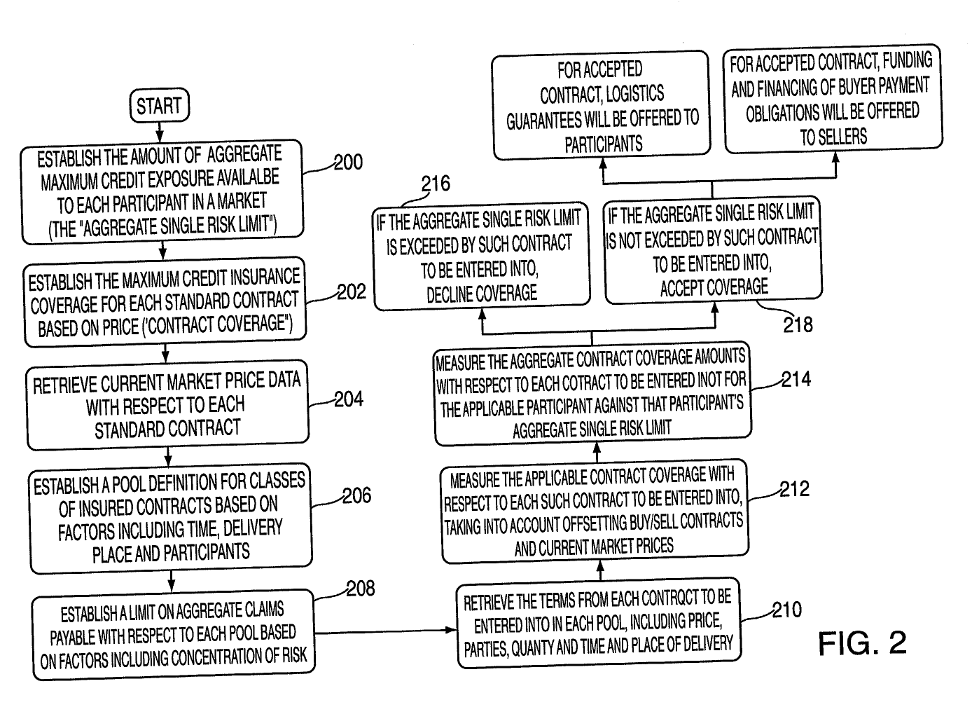

FIG. 2 illustrates a program of instructions which operate on the computer system 10 for carrying out the method of the present invention. In particular, the program illustrated in FIG. 2 implements a system for trading electrical energy. As a product, electrical energy is traditionally illiquid because electrical energy cannot be efficiently stored on the scale necessary to supply major markets such as California. Once electrical energy has been generated, it must be delivered, and conversely, when electrical energy is to be delivered it must be generated. Traditionally, then, buyers and sellers of electrical energy make individual arrangements to coordinate delivery of a certain amount of electrical energy at a specified time for a price to be paid at a later time after delivery, or generating companies agree to service grid operating entities through a system of spot markets.

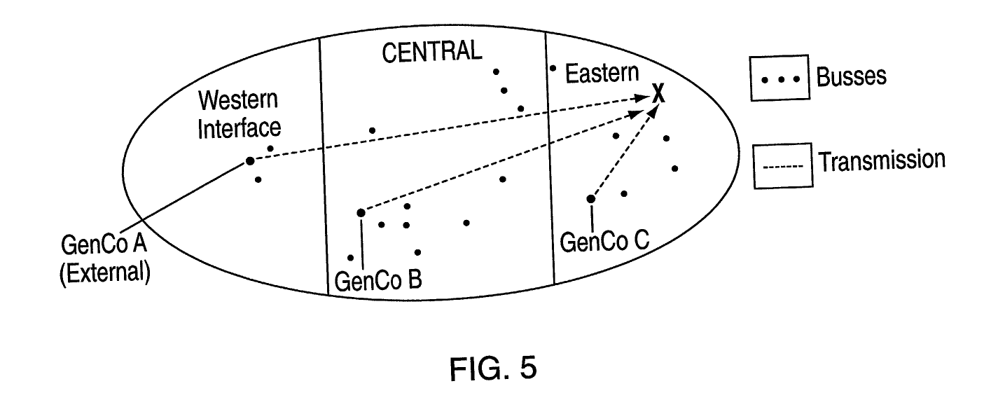

As shown in FIG. 5, for example, load serving entity (LSE) X, in Independent System Operator (ISO) Eastern region, is to be delivered electrical energy. LSE X is indifferent to the actual entity that delivers the energy as long as the costs are the same. However, because generator company A and B are not within the Eastern ISO, their costs will generally be higher than C's. Moreover, generator capacity at specific times are other parameters that distinguish suppliers and lead buyers and sellers to rely on traditional individual relationships.

The program illustrated in FIG. 2 creates an alternative trading system for the electrical energy market. Initially, in step 200, an Aggregate Single Risk Limit (“ASRL”) is established. The ASRL is the maximum credit exposure available to each participant in the market. The ASRL may be different for each participant—that is, participant “A” may be allowed $X million of available credit (determined by an evaluation of collateral, past credit history, etc.) and participant “B” may be allowed $Y million of available credit. Then, in step 202, the Contract Coverage is established. Contract Coverage is the maximum credit insurance, based on contract price, coverage for each standardized contract. For example, a particular contract may be priced at $M but may be insured for a maximum of $N where $N is the Contract Coverage.

In addition to establishing the ASRL and Contract Coverage, the computer system 10 (FIG. 1) collects data concerning the current and future electrical energy market from a number of contract aggregators. Contract aggregators are exchanges or other entities which engage in entering into or matching contracts for the delivery of power. At any one time, such entities generate and maintain lists of contracts to supply energy to buyers (such as LSE X) from sellers (such as generator company A). Based on these contracts, a certain amount of electrical energy, for delivery at a certain place, at a certain time and price is supplied through a transmission system and monitored by the contract aggregators.

Through its network connections, the computer system 10 retrieves the data concerning the individual contracts from contract aggregators. Each Contract will be standardized for the delivery of a specific amount of power during a specific time period. In addition to specifying the month of delivery, the Contract Units will specify the day and time of day of delivery, allowing for 24 hour delivery 7 days a week for base load Units and 16 hour delivery during non-holiday weekdays for peak load Units. The following outlines an example structure of contract Units:

a. 10 MW Base load Units: these Units will represent the delivery obligation of seller for 10 MW each hour, 24 hours per day, 7 days per week for a specified month.

b. 5 MW peak load Units: These Units will represent the delivery obligation of seller for 5 MW each hour, 16 hours per day, weekdays excluding any holidays, for the specified month.

Standardization for delivery is achieved within the risk transfer conduit system by designing the Contract Units for specific delivery to a point within a managed grid such as an ISO such that transmission costs from any delivery point within the specified ISO area (as defined by the Contract Unit) to any buyer inside the same ISO, are equal. A buyer must be indifferent to the bilateral Power Contract counter-party from a locational standpoint, in order to be able compare the offer prices of different generation companies. The standardized delivery point becomes any point within the Contract Specific ISO area (or regional Contract area with characteristics similar to an ISO).

In step 204, using data collected from the contract aggregators, market pricing data for electrical energy contracts as a function of time, place of delivery and quantity is generated. In addition to the data collected from the contract aggregators, the computer system 10 also retrieves or receives other market information concerning the electrical energy market. For example, certain energy generating companies supply current and future anticipated market prices for electrical energy which is transmitted to the computer system 10. Also, computer system operators may input predictions of market prices made by industry analysts. This market information on the current and future price of electrical energy is combined with the data from the contract aggregators (through averaging or other standard statistical techniques) in step 204 to produce estimates of current market prices for electrical energy for certain delivery amounts at certain times to specific geographical areas. Estimates of future market prices are also produced. At any one time then, the trading system operating according to the program illustrated in FIG. 2 tracks its best estimate of the market price for electrical energy on a current basis and over future time periods.

In step 206, a pool definition is established. A pool aggregates those contracts which are to be insured as a group. Pooling the contracts reduces the effective allocated risk on any one contract. That is, because it is statistically unlikely that all contracts in a group will not be performed, the overall risk of non-performance at any one time for the group is less than the individually allocated risks. Accordingly, because the effective risk of the portfolio is reduced, the portfolio is insured for a premium that is less than the sum of individual premiums that would be required for each individual contract, even though each individual contract is fully insured.

Commonly, the pool definition groups energy contracts according to delivery region. For example, all buyers and sellers of energy contracts having delivery in the Northern California hub may be treated as pool “1”. A variety of different pool definitions based on delivery time or interval, place, quantity and/or participant designation may be established. Once pool definitions have been established, a pool limit is established in step 208. A pool limit is the maximum amount of insurance payable with respect to each pool. That is, the total insurance payable for any one pool will only be a fraction or set percentage of the total value of the contracts in the pool. Any one contract (or subset of contracts) may be fully insured as long as the total limit for the pool is not exceeded. To the extent the pool limit is exceeded, individual contracts may not be fully insured. The pool limit is established based on the characteristics of the pool (delivery location, delivery history, participants, etc.), including the concentration of risk in any one (or small number of) participants.

After the pools have been defined and appropriate pool limits established, the standardized terms from each contract entered into, in each pool, are retrieved in step 210. As noted above, these contract terms are available from the contract aggregators. The standardized terms retrieved for each contract are i) buyer/seller designation, ii) price, iii) quantity, iv) delivery time and/or interval, and v) delivery place and/or region. Once the information associated with steps 200 to 210 has been gathered, the applicable contract coverage with respect to each contract in the pool is measured in step 212. Measuring the contract coverage consists of determining the financial loss which would occur n the event a party to the contract fails to perform under the contract. This determination of financial loss takes into account the current and expected market prices (depending on delivery date) for the energy delivered to the contract delivery point at the delivery time, as well as the contract price. It also takes into account offsetting buy and sell contracts for energy. The measurement 212 of the contract coverage occurs on a real time basis as new information concerning the market price is available.

Once the contract coverage has been measured in step 212, it is compared against the maximum limit for each contract (i.e., “Contract Coverage”) and against the limit of contract coverage for each participant (i.e., “ASRL”) in step 214. If the measured contract coverage falls within the ASRL and contract coverage, the contract will be accepted and insured in step 216. If the measured contract coverage is outside of the ASRL or Contract Coverage, it will not be accepted in step 218. Because the system of the present invention automatically makes the determination of whether to accept (or not) energy contracts as they are presented based on the latest market data, the exposure to the insurer can be more easily managed within the pool limits, and hence, the stability and liquidity of the energy market enhanced.

Once the contracts have been insured, the trading system of the present invention monetizes the transactions. The transactions can be immediately monetized because the delivery obligation and the unfunded payment obligation of the transaction has been insured from the date of the contract. The delivery obligation refers to the sellers obligation to deliver an amount of energy to place at a certain time. The payment obligation refers to the buyer's obligation to pay a certain price for delivery of energy. Traditionally, although the delivery obligation could be insured (albeit at a higher rate than according to the present invention), the payment obligation was not insured until after the delivery date. In the present system, the payment obligations are pooled and insured just as the delivery obligations were pooled. The pooled payment obligations are insured from the contract date. Because the entire transaction, delivery and payment obligations, are insured from the contract date, the transaction can be monetized (i.e., add) immediately. That is, the electrical energy contracts can be bought and sold just as other commodities contracts.

The risk allocation methods used in implementing the program of FIG. 2 are also generally applicable to markets other than electrical energy.

The risk transfer conduit system acts as an intermediary to transfer all or a portion of these counter-party risks from these electronic exchange systems and conventional exchanges to the capital, insurance and re-insurance markets. The risk transfer conduit system provides assurance to both buyers and sellers, as well as to financial participants in hedging contracts. It assures a seller of a product or service in a business-to-business marketplace that it will receive payment at the contracted price. The reasons for nonpayment are numerous including unwillingness to take the goods or services, inability to pay due to financial straits, a dispute relating to the contractual conditions including delivery, quality, quantity or other terms of the contract. This risk is generally equal to the contract price.

The system assures a buyer of a product or service in a business-to-business marketplace that it will be delivered that product or service under the contracted terms subject to a cap on losses in the event of seller default. The risk to a buyer in a transaction is the risk that the seller does not perform. In this case the risk is calculated as the difference in the contract price under which the seller had promised to deliver, and the cover price, which is the price a buyer must pay to replace the non-delivered goods or services at the contracted time for delivery.

The system further assures each counterparty of a financial hedging contract of the performance of the other party. Performance in such a case is payment at a date of a sum based on then current prices for the subject product and the terms of the contract. This system would provide for a capped assurance to each side.

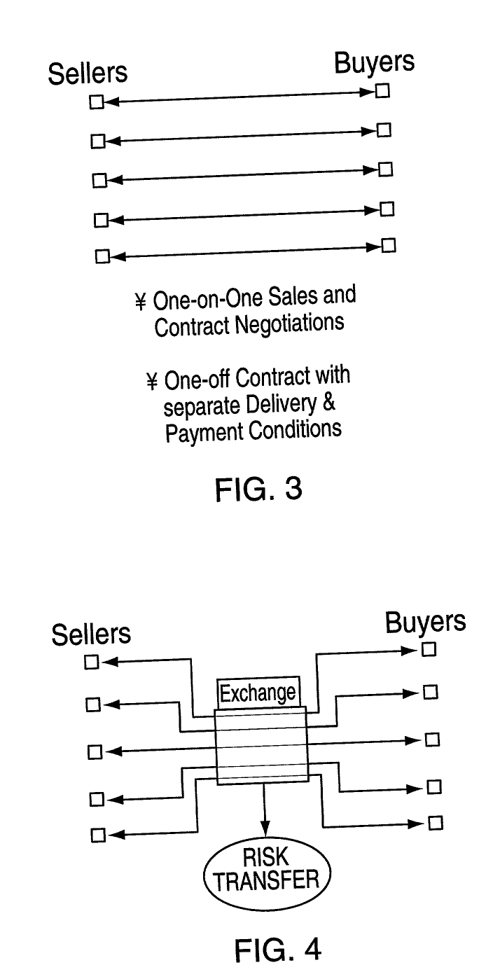

Prior to electronic exchange systems, counter-party risk related to contracts for the purchase and sale of most goods and services (i.e.—goods and services other than goods traded on traditional, organized commodity exchanges, described below) and ran exclusively between parties. It was not intermediated by any institution or market space. Reference is made to FIG. 3 where a graphical representation of this type of non-intermediated transaction in accordance with the prior art is represented. Since these transactions were not intermediated, they were not aggregated by any party. In addition, contracts for these classes of goods were not uniform and parties sought performance assurance through an analysis of an individual counter-party's credit-worthiness or through financial guarantees such as letters of credit and performance bonds. This type of transaction required a seller to locate a specific buyer and negotiate the terms of the sale transaction on a one-to-one basis. While each seller generally had its standard form of contract, each buyer typically had its own form of purchase order with terms and the law of contracts and particularly the Uniform Commercial Code dealt with the sale of goods between merchants in Article 2 which has the subject of a multitude of litigation. Other types of transactions of this sort were dealt with under general contract principles. This approach, while certainly workable, limits the ability of sellers to find and deal with buyers and buyers ability to deal with a wide selection of sellers. Generally, sellers needed to assure themselves that the buyers were serious, reliable and financially able to make the payment when delivery of the goods or services was made. Similarly, buyers had to satisfy themselves that the sellers were capable of producing or acquiring the goods or services they were to deliver and reliable in executing such performance. In addition, when buyers would buy similar goods from different vendors there was no likelihood that the terms of the agreement would be the same or that the other parameters would be similar. Certainly, this approach increases the administrative cost of the sale transaction on both sides and makes insurance against counterparty risk the willingness to litigate or arbitrate a claim between the parties. As important is the absence of liquidity in the market and the ability to quickly and easily locate a market price which other participants will buy and sell the products for without significant effort.

Certain fungible and easily storable goods, typically referred to as “Commodities”, have often been bought and sold via organized exchanges rather than through bilateral transactions described above. These exchanges matched offers to sell with offers to buy, thereby permitting anonymous trading and uniform credit. A principal advantage of the exchange system is liquidity. Since contracts are anonymous and uniform, parties can liquidate their positions without extensive negotiation and at a more predictable price. Elaborate collateral systems were developed for use by these exchanges to assure participants that their interests would be protected in case of a default by other participants. Reliance on a collateral system for exchange participant security is reasonable when certain conditions exist. These include uniform pricing and liquidity of trading. Uniform, transparent and discernable spot market pricing of the commodity for future delivery allows the exchange to calculate accurately the amount of collateral required to keep counter-parties whole under pricing conditions that obtain at the time of calculation. These collateral requirements are generally known as margin requirements which require a market participant to have sufficient equity to meet some specified percentage of the value of its contracts. A liquid market for forward purchase and delivery contracts is essential so that, in the event of a default prior to the delivery date, the exchanges can readily find a party to assume the defaulting party's position in the contract, before market moves could make the collateral on hand insufficient. These conditions are attributes of traditional “Commodities”. However, other goods and services are now capable of being trading on a similar basis in accordance with the systems of the applicants, invention in a business-to-business virtual market.

With the advent of electronic exchanges, businesses now contract with each other online or through other electronically-aided means for the purchase and sale of goods and services that are not traded on traditional, organized exchanges. The mechanics of transacting trades of non-commodities and the typical terms of sale are converging with those applicable to Commodities exchanges. For instance, the counter-party risks involved in a non-commodity trade now exist in definable locations, i.e. the online sites or other electronic media for business-to-business trading. Reference is made to FIG. 4 wherein a business to business electronic exchange is shown graphically. Business-to-business exchanges have attempted to implement various credit assurance mechanics to imitate the anonymity and uniformity of commodities exchanges. However the nature of the goods and services sold render these methods uneconomical and/or unworkable. Generally, these systems examine each transaction by itself and attempt to securitize the transaction. This has the result of either failing because the securitization is inadequate or restricting the ability of parties to deal such that there is no meaningful improvement over the non-aggregated non-intermediated model of FIG. 3.

The counter-party credit transfer conduit system is a unique conduit system to transfer aggregated counter-party credit risks from the electronic marketplace to the insurance, reinsurance and credit-derivatives markets. Transfer to one or more of these markets is known as syndication The method aggregates contract performance risks by tracking them via its method of operation(described below) and insuring these risks on a portfolio basis. Specifically, the system treats the electronic market place as a focal point for the aggregation of Contract Performance Risks, permitting the capture of those risk pools. Each risk pool is analyzed as a portfolio of risks representing contract performance obligations which exist during discrete time periods.

The risk transfer conduit system is structured such that it is applied to each trade in a market, and the resulting coverage of a high number of performance and credit risks are treated as a portfolio of risks. This achieves a pricing benefit for the consumer (which in this case is either user of the marketplace, i.e. buyer or seller). It provides the ancillary benefit of liquidity which will attract market participants who will use the market to hedge their operations(something not available to them in bilateral arrangements or existing electronic sites). Other ways to provide contract performance assurance exist, such as bank letters of credit and individual event insurance policies, but these methods are more expensive, and are handled one client and/or one transaction at a time.

It is important to note that the benefits of the risk transfer conduit system are automatically provided to both buyer and seller when they consummate a trade on a risk transfer conduit system enabled system. If either party defaults, that position is covered by security provided by the system and the performing counter-party remains unharmed.

The approach to counter-party risks in accordance with the invention is unique in that it treats market activity as a portfolio of credit risks. While each contract is covered up to a limit considered adequate by Buyers and Sellers, total claims in respect of a portfolio are limited. Using statistical analysis of the risk portfolios, the system operators can limit the system's coverage to a percentage of the portfolio based on expected loss scenarios, thereby limiting the cost of coverage.

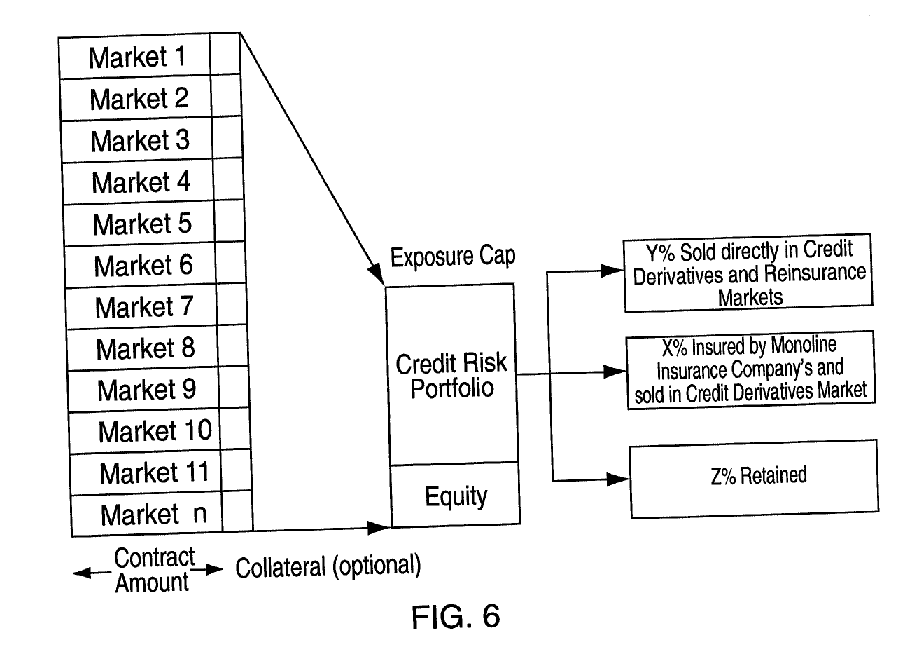

Reference is made to FIG. 6 wherein a graphical representation of the manner in which the risk portfolios are established and the credit risk portfolio sold to others(with the possibility of retaining some percentage) is depicted.

In the example of FIG. 6 the credit risk portfolio includes an equity component and a credit risk portfolio up to the exposure cap. The exposure cap is established in the system so that the system need only pay the actual damages of a party from its counter-party's lack of performance up to some limit, generally a percentage (which may be greater than 100 percent) of the contract price. Then, the credit risk portfolio is secured by the system when it sells of pieces of its risk exposure to insurers. In the example of FIG. 3 some percentage (Y%) is sold directly in credit derivatives and reinsurance markets, another percentage (X%) is insured by monoline insurance companies and sold in the credit derivatives market, and the remaining percentage (Z%) is retained by the system as its own risk, secured by its equity. Depending on the market place and the financial goals and resources of the system, the varying percentages, and the sale of the risk to other markets is set by the system's management. However, from the seller or buyer's perspective, this reinsurance structure is irrelevant. The seller or buyer merely knows that in the event of non-performance by its counter-party the system will make good on the sale up to the exposure cap for a transaction and that the system's credit is satisfactory.

The risk conduit transfer system in accordance with the invention is an alternative to the one-by-one credit analysis of the traditional business-to-business bilateral contract and to the collateral-based system used by traditional exchanges. In each of those approaches, the credit focus is on each individual transaction. The current system uses portfolio analysis to limit the coverage in a more cost effective way. The coverage structure also provides more effective assurance than the collateral system.

The current system in accordance with the invention can also be employed in tandem with a collateral-based system, since both are designed to provide assurance in the context of anonymous, standardized contracts. In this type of application, contract performance assurance would be used in lieu of collateral or financial guarantee instruments procured by participants since it is less expensive and more reliable than collateral or diverse financial guarantees. Collateral would be used by participants that do not qualify under portfolio standards and for trading by approved companies in excess of aggregate maximum credit risk coverages. In this application, such additional collateral might be arranged between the market participant and the system operators, rather than between the party and its counter-party.

The performance obligations insured will derive from contracts for the purchase and sale of goods and services and from financial hedging transactions. The key terms in a contract for purchase and sale will include: quantity of item or service sold; price and terms for payment; time required for delivery (depending on the good or service, it could be a specific time, delivery over a period or delivery at a time within a period); place of delivery (typically a transport hub so that contracts will be uniform and not dependent on actual points of origination or destination, e. g. , X product delivered at Y hub); and quality specifications for a product or service.

The seller's obligations will be to deliver the specified goods or services at the time and place stipulated. If the seller fails in performing that obligation the system operators may be entitled to perform on the seller's behalf. In most cases the system operators will however, be able to purchase another contract to cover the obligation to deliver. If it is impractical to perform on the seller's behalf, the contract of assurance will assure payment of the lesser of the actual cost of covering failed performance or a specific contract-related cap, based on the contract price. This obligation may also be limited by a limit on aggregate losses on the entire pool of risks of which the contract is a part. Each seller will provide an indemnity to the system operators or otherwise assure repayment of amounts paid under the system operators contract of assurance.

The buyer will be required to pay a purchase price upon performance by the applicable seller or by the system operators on behalf of that seller. Upon non-performance by a buyer the seller will be paid the amount required to cover losses in price received for the goods or services, up to a contract-related cap. This obligation will also be limited by a limit on aggregate losses on the entire pool of risks of which the contract is a part.

Each seller will provide an indemnity or otherwise assure repayment of amounts paid under the contract of assurance. Each buyer will provide an indemnity or otherwise assure repayment of amounts paid under the contract of assurance. Covered parties in financial hedging contracts will provide an indemnity or otherwise assure repayment of amounts paid under the contracts of assurance.

When a party signs up to participate in a risk transfer conduit system enabled market trading system, it will enter into two separate agreements before it can conduct any trades on the system. The first is a master bilateral purchase/sale agreement. The second is a master credit facility.

The master bilateral purchase/sale agreement constitutes the standardized bilateral contract for all trades undertaken by a market participant and outlines the basic terms and conditions of the sale and purchase of the product. When a seller offers a quantity of product in the market, Price, Delivery Date and Delivery Place will be specified. If a buyer bids for and buys the product, these offered terms, together with the general contract terms of the Master Bilateral Agreement constitute a legally binding contract between parties who remain anonymous to each other. The master bilateral contracts may be devised jointly with entities other than the system operators. Generally, different terms may be established for different types of products and services, with terms familiar to the industry involved.

Under the master credit facility, the terms and conditions of a credit assurance facility (the “Facility”) which will cover buyer and seller defaults is entered into as a condition, or option, of participation in the market. This Facility will outline the costs of basic coverage, the terms of payment, the payment caps, credit requirements necessary for participation and actions taken in the event of the occurrence of a credit event by a participant. Similar to the master bilateral agreement, when a trade is consummated between market participants, a contract purchase price, delivery date and delivery place are defined in the Facility and a binding legal agreement is entered into between: the Buyer and the system operators(or a designated Credit Facility Provider); and the Seller and the system operators. The contract between the buyer and the system has the buyer guaranteeing payment of its contractual obligation, agrees to pay a transaction fee to the system operators, and receives assurance from the system of delivery of the contracted product subject to certain limitations.

In the case of the seller's contract with the system, the seller guarantees the system full payment of the cost of covering the contract, which will be the cost of the replacement goods in the spot market, submits to pay a transaction fee, and receives assurance from the system for the payment by the buyer, subject to certain limitations.

In order to transact on an exchange in contracts assured by the system in accordance with the invention, participants must be approved by the system. The aggregate maximum credit risk coverage will limit the amount of exposure to the participant's credit which will be accepted by the system. Credit exposure will be based on the total price of contracts assured by the system that are outstanding and that involve the participant. The participant will not be permitted to trade beyond this limit unless an increase is granted by the system or some pre-arranged collateral or credit enhancement is provided by the participant.

The system will assess its exposure to a participant on all systems covered by system assurances and will analyze offsetting positions in establishing limits and calculating exposure. For instance, a participant that agrees to sell a quantity of a product at a given time and place on Exchange A, and agrees to buy the same quantity of the same product at the same time and place on Exchange B, may have a net zero exposure to the system if the price of contracts is the same. Alternatively, contracts will be netted, across exchanges if necessary, under the methodology described below.

To make the risk conduit transfer system operate there must be a reliable method of capturing risk and gathering data. The system connects directly to an electronic exchange, and receives the following data on a real time basis: participant bids and offers on specific contracts; matched trades, reflecting offers and bids which are matched and which create contractually binding obligations on a buyer and seller; outstanding bids and offers of each participant which are compared and matched when they are for the same price; and matched trades in which participants have a position within the aggregate maximum credit risk coverage placed on the particular participant by the system's Credit Management Department. The system then sends in real time an approval code to the electronic market, which will then manage the participants as they enter bids and offers.

Although the system manages its exposure to any particular participant, the system does not underwrite each contract counter-party individually. Rather, the risk conduit transfer system in accordance with the invention aggregates contracts into Predefined Pools and insures the pooled risk. This approach to transferring risk (through insurance) from an entire electronic marketplace is an entirely new approach to achieving counter-party security within such a market.

Each contract within a Predefined Pool is insured up to a percentage value (which may be greater than 100%) of the Contract Price (the “credit risk coverage limit”). The credit risk coverage limit will be set by the system, and will vary according to contract and marketplace demands. Insurance covers damages related to a non-performance of both the Seller and the Buyer. In addition to designating the Credit risk coverage limit, the system designates a total cap for the Predefined Pool (the “Pool Cap”).

The Pool Cap represents the total maximum exposure covered by the system for a particular Predefined Pool, and is set by the system and will vary according to each Predefined Pool and marketplace. This unique function of the risk conduit transfer system allows for an extremely competitive pricing structure.

The risk conduit transfer system software calculates the total exposure in the Predefined Pool on a real-time basis, storing this data in a main system database. Each matched purchase and sale contract adds exposures on each side of the transaction to the total exposure in the predefined pool.

The risk conduit transfer system compiles the total exposure of the Predefined Pools of risk for various contracts within various marketplaces. This portfolio of combined risk represents the risk which the system is transferring from the electronic markets. The system then segregates this risk portfolio into various risk tranches ranging from first loss equity positions to AAA-Insured positions (see FIG. G. above). This is analogous to the tranches created in the securitization of loan portfolios. This placement activity is an ongoing process integral to the risk transfer conduit system operated in accordance with the invention.

Because the contract performance assurance covers each trade in a marketplace it creates a large portfolio of corporate credit risks on an ongoing basis. The contract performance assurance prices its insurance coverage based on this portfolio approach, and is therefore able to compete aggressively with banks and property and casualty insurers.

Once the contract performance program assurance of the risk conduit transfer system has created a critical mass of credit facility applications in its target markets, the system will initiate a process in which the credit risk associated with the contract performance assurance program master credit facility will be partially securitized and placed into either the insurance market, the reinsurance market or the credit derivatives market.

The system will develop its credit facility portfolio by either direct placement with AAA monoline insurers; or direct provision of the master credit facility. The system may decide to place credit risks generated under application of the contract performance assurance program master credit facility directly with a AAA monoline insurer, which will access the reinsurance market and credit derivatives market as required.

In the case of direct provision of the master credit facility, the contract performance assurance program would enter directly into the Master Credit Facility and would then periodically place the credit risks of that portfolio (together with any required system equity) into insurance, reinsurance or credit derivatives markets.

There are several aspects of risk management which the contract performance assurance program builds into its system, ranging from pre-screening to risk fee pricing. The process compensates the contract performance assurance program for covering the actual risks of a portfolio, and gives the market participants an adequate level of coverage at an attractive price.

In the event that a market seller fails to make delivery of the products contracted for, the contract performance assurance program will cover the difference between the Contract Price and the Cover (Spot market) Price, up to the Price Cap. The Price Cap will be defined in the Master Credit Facility as a percentage of the Contract Price. In the event that the Spot Price exceeds the Price Cap, the contract performance assurance program will retain the right to make a cash payment to the buyer in the amount of the difference between the Contract Price and the Price Cap, and the buyer will have the option to cover the contract at market prices.

In some of the target markets forward spot markets either do not exist or have poor liquidity. The system will manage an independent Product Forward Index(“PFI”) as a method of establishing a forward curve in the target market products for market participants. The PFI will be utilized by buyers, sellers and the contract performance assurance program to calculate their risk positions at various forward pricing points.

The system, or other operator of the contract performance assurance program will charge a basic fee for its coverage, equal to a percentage of the risks inherent in the contracts outstanding. This fee will be partially paid by the buyer in an amount equal to a percentage of the Contract Price or a percentage of the average PFI from contract initiation until the delivery date and partially paid by the seller in an amount equal to either a percentage of the Contract Price times the Coverage Period or a percentage of the average PFI from contract initiation until the delivery date. Payment of this fee will be partly up front and partly billed monthly in arrears on a balanced accounts basis.

The contract performance assurance program will establish minimum credit requirements for participation in the markets. These participation requirements shall be based on providing either one or both of a minimum credit rating from a recognized U.S. rating agency and a letter of credit from a bank, meeting the minimum credit rating requirement, in an amount equal to a percentage defined in the master bilateral contract.

The software for operating the risk transfer conduit system and the contract performance assurance program performs the following functions related to the business methods of the risk transfer conduit system: (1) data capture; (2) limit calculation; (3) calculating the risk transfer conduit system's exposure; (4) calculating a product forward index (PFI); (5) performing verification functions; (6) generating hedging position data; and (7) collecting and distributing administrative data.

(1) The data capture is performed via a dedicated data line or Internet connection to individual marketplaces and aggregations points of risk. The software system will capture: outstanding offers of a contract (from sellers); outstanding bids for a contract (from buyers); matched trades (which are outstanding contracts for which the delivery date has not yet arrived). All data pertaining to the contracts in question will be contained in the data capture. The relevant contract data will include: contract definition; offer price; bid price; and the matched trade price.

(2) The limit calculation in the software system will provide individual participant trade limits to electronic markets on a real-time basis. Limits will correspond to both total contract value and contract term and will take into consideration off-setting positions and positions in multiple markets. If a credit event occurs with regard to a participant, limits may be altered by the system software, and the risk transfer conduit system will automatically react to these alterations. The system software will automatically determine which, if any, contracts should be covered to reduce a participant's outstanding contract positions to new limit levels, and the software system will have a capability to execute such cover in the market. Generally, the software will notify an operator who will need to authorize such a cover operation.

(3) The software calculates the risk transfer conduit system's exposure. Based on data related to outstanding matched trades, the predefined pool definitions, individual contract coverage and overall limits on coverage of the predefined pool, the system software will calculate the maximum exposure of the entire risk transfer conduit system portfolio. Utilizing market pricing indices (which may be generated by the system software) the risk transfer conduit system's exposure to individual credits (market exposure)will be calculated. This information will be readily available to the system software.

(4) The calculation of a Product Forward Index (PFI) is performed by the system software which will track activity of the markets it covers and will receive additional data inputs regarding forward pricing. This price would be the price at which a given contract could be expected to trade on the day of calculation. The system will then calculate a Product Forward Index to be used in calculating exposure to individual entities. For instance, a contract for sale of product A for delivery six months from a given date would require a price of $X to induce the Buyer and Seller to agree when entered into, 3 months later because of market movements the required price would be $Y. One component of the PFI will be actual market sampling, comprised of automated downloads and analyses of market trades of the contracts in question on the date of the calculation of the PFI for such contract. These market observations will form the basis for adjustments to the PFI by the system software as a result of PFI management as described below.

In addition to sampling of actual market trades for a particular contract, the system software will establish a canvassing program in which participants will submit their price suggestions, (along with liquidity premiums or discounts for different volumes) via secure electronic communication. The system software will submit a daily schedule of contracts, terms and quantities, and will request pricing information from its covered participants. This information will be compiled along with the Market Sampling data to form the final PFI. During market canvassing, the participants will be asked to submit Liquidity Premiums and discounts (for sale and purchase) of larger volumes of contracts. This Liquidity Factor will then be utilized together with the PFI in calculating the risk transfer conduit system's exposure to a participant resulting from a net position in a particular contract.

(5) The system software verifies delivery of the contracted Commodities through a tracing system which receives data from Sellers and other systems with regard to, transportation, transmission and/or shipping information. In addition the system software verifies payment through a similar tracking system with Buyers, in which information regarding payments is forwarded to the system software. Internally, the system verifies receipt of payments due to the risk transfer conduit system from its electronic marketplace clients.

(6) The system software will continuously monitor the PFI for each contract in which it maintains an exposure, and will monitor information provided by hedge providers to identify and implement hedge positions which will optimize the value of the risk transfer conduit system's risk portfolio.

(7) The system software also controls and provides administrative data to the risk transfer conduit system administrators. The system software provides real-time data to the risk transfer conduit system administrators and the software's administrators related to settlement and clearing of the risk transfer conduit system's standardized contracts. Buyers and Sellers accounts are debited and credited based on the output of the system software settlement and clearing functions.

(8) A sample of the functionality used in connection with the system software is provided. The sample functionality includes a description of the data capture, data provided from the marketing, clearing and settlement services of the risk transfer conduit system and system software, the data provided by the risk transfer conduit system's credit management services, calculations relating to exposures of the risk transfer conduit system to a seller default, calculating exposures to buyer default and calculating net contract exposures of a market participant(including all activities both as a buyer and a seller),

A. Data captured from a variety of different types of market engines, trade matching systems or other aggregation points will include:

1) K_{(Q,t=d-p,place)}=Contract Definition

This includes product definition, quantity, time of delivery and payment (t=d−p), and place of delivery;

2) P_{K}=Price of Contract

3) Participant(s)=Participant(s)

(registered as buyer or seller in contract)

B. Data Provided from virtual market risk transfer conduit system Marketing, Clearing and Settlement Services:

1) PFI_{K}=Price Forward Index

For Contract K, for delivery of Q at time=t, at specified place of delivery;

2) LFₚ=Liquidity Factor Premium (LFₚ)

Indicates the premium over the PFI which would be applied to the purchase of a larger volume of contracts;

3) LF_{d}=Liquidity Factor Discount (LF_{d})

Indicates the discount from the PFI which would be applied to the sale of a larger volume of contracts.

4) P_{K,M,t=d} Market price of the contract at

delivery date of contract

C. Data provided by the risk transfer conduit system's credit management services:

1) _{TLparticipant}=Total Limit of Participant

Indicating the dynamic view of the virtual market risk transfer conduit system as to the total exposure to a participant that the risk transfer conduit system can accept, based on credit considerations;

2) P_{K,f}=Price Floor of Contract, K

Price floor associated with coverage of payment risk of a particular contract (K_{(Q,t,place)}), to which the coverage is attached. This price P_{K,f} can be either a fixed price or a fixed percentage of the contract price, P_{K}, and represents the minimum price of the contract K which would be used in calculating the risk transfer conduit system's exposure to buyer defaults prior to delivery.

3) P_{K,C}=Price Cap of Contract K

Price Cap associated with coverage of delivery risk of a particular contract (K_{(Q,t place)}), to which the coverage is attached. This price P_{K,c} can be either a fixed price or a fixed percentage of the contract price, P_{K}, and represents the maximum price of replacing contract K which would be covered by the risk transfer conduit system if a seller fails to deliver.

4) V_{d,tk,p}=Verification Triggers

(d=delivery, tk=take, p=payment)

0—indicates no verification information available for Contract K

1—indicates delivery, taking or payment is verified

2—indicates non-delivery, non-taking or non-payment is verified.

D. Calculating Exposures to Seller Default. This equates to default by seller in delivery of contracted goods in compliance with the delivery terms in contract. The virtual market risk transfer conduit system calculates maximum possible exposure to seller (E_{s,K,max}) and actual exposure (E_{s,K act}), related to a contract K, as follows:

1) Requisite information: K_{(Q,t=d-p,place}), P_{K}, PFI_{K, P}_{K,C}

(where d=delivery date, and p=payment date);

2) Maximum Exposures: Maximum exposure associated with the contract (E_{s,K,max})=(P_{K,C}−P_{K});

3) Actual exposure associated with the

contract is:

a) Prior to delivery date (t<d):

then

If (PFI_{K}*(1+LFₚ))>P_{K}, then

If (PFI_{K}*(1+LFₚ))>P_{K,c} then:

E_{s,K,act}=(P_{K,C}−P_{K});

Else, E_{s,K,act}=(PFI_{K}* (1+LFₚ)−P_{K});

Else, E_{S,K,act}=0, and

b) At or after delivery date (t=d):

If V_{d}=0 or 2, then

If (P_{K,M,t=d}>P_{K}) then

If (P_{K,M,t=d}>P_{K,C}) then:

E_{S,K,act}=(P_{K,C}−P_{K});

Else, E_{S,K,act}=(P_{K,M,t=d}−P_{K});

Else, E_{s,K,act}=0

Else E_{s,K,act}=0 (ie. when V_{d}=1)

E. Calculating Exposures to Buyer default. This equates to default by the buyer prior to compliance with the payment terms in contract. The risk transfer conduit system calculates the maximum possible exposure to buyer (E_{b,K,max}) and actual usage of exposure (E_{b,K,act}).

1) Requisite information: K(_{Q,t=d-p,place)}, P_{K},

PFI_{K}, P_{K,f} and payment date t=d (where d=delivery date);

2) Maximum Exposures:

Maximum exposure associated with the contract (E_{b,K,max})=(P_{K});

3) Actual exposure associated with the

contract is:

a) If 0≦t≦d then

If (PFI_{K}*(1−LF_{d}))<P_{K} then

If (PFI_{K}*(1−LF_{d}))<P_{K,f} then

E_{b,K,act}=(P_{K}−P_{K,f})

Else E_{b,K,act}=(P_{K}−(PFI_{K}*(1−LF_{d}))

Else E_{b,K,act}=0

b) If t≧d then

If V_{d}=0 or 1 then;

If Vₜₖ=0 or 1 then;

If Vₚ=0 or 2 then;

E_{b,K,act}=PK;

Else Vₚ=1 and E_{b,K,act}=0;

Else Vₜₖ=2 and

If (PFI_{K}*(1−LF_{d}))<Pₖ

then

If (PFI_{K}*(1−LF_{d}))<P_{K,f} then

_{b,K,act}=(P_{K}−P_{K,f})

Else E_{b,K,act}=(P_{K}−

(PFI_{K}*(1−LF_{d})

Else E_{b,K,act}=P_{K Else V}_{d}=2 and;

If Vₜₖ=0 or 1 then;

If Vp=0 or 2 then;

E_{b,K,act}=P_{K};

Else Vₚ=1 and E_{b,K,act}=0;

Else Vₜₖ=2 and E_{b,K,act}=0

F. Calculating Net Contract (K) Exposures of a Participant. The total position of a participant to a contract K_{(Q,t,place)} will equal the average long and short positions in any contract;

1) Short Position=Σ₀₋ₙ (number of all contracts Kⁿ_{(Q,t,place)} in which Participant is registered seller)

a) Short Value=Σ₀₋ₙ (Kⁿ*Pⁿ_{K}) of each contract in which participant is registered seller)

b) Average Short Price=Total Short value/Short Position

2) Long Position=Σ₀₋ₙ (number of all contracts

Kⁿ_{(Q,t,place)} in which Participant is registered buyer)

a) Long Value=Σ_{0-N} (Kⁿ*Pⁿ_{K}) of each contract in which participant is registered buyer)

b) Average Long Price=Total Long value/Long Position

3) If Long Position>Short Position,

a) Net Long Position=Long Position−Short Position

b) Net Long Contract Value=(Net Long Position*Average Long Price)+(Short Position)*(Average Long Price−Average Short Price)

4) And if the Long Position<Short Position,

a) Net Short Position=Short Position−Long Position

b) Net Short Contract Value=(Net Short Position*Average Short Price)+(Long Position)*(Average Short Price−Average Long Price)

As an example of the application of the risk transfer conduit system to a product that is not currently traded as a commodity and for which there is a substantial need for the benefits of commodity market pricing and liquidity, the risk transfer conduit system is applied to the trading of electricity contracts.

In addition to the basic risk transfer conduit system, a logistics optimization system for delivery of the products traded under the risk transfer conduit system was developed to minimize the total costs of shipping or transporting a pool of contracts. This is done, as described below, by evaluating a portfolio of contract trades and then optimizing the delivery costs by pairing up the buyers and sellers, whose identities are not known to each other, in a fashion which reduces the overall shipping costs for all deliveries.

The logistics optimization system can retain the right to reorder delivery of goods among standardized contracts once trading in those contracts has ceased. Because trading in covered standardized contracts is anonymous and the performance risks are covered by the risk transfer conduit system, the virtual market electronic marketplaces are able to utilize a virtual clearinghouse system. The virtual clearinghouse system (VCS) provides a number of unique functions. VCS establishes nominal deliver nodes for each contract covered by the virtual market system. Reference is next made to Fig wherein a graphical example of shipment to a Montreal node for forestry products in accordance with the risk transfer conduit system, but not the logistics optimization system is depicted. VCS calculates a delivery cost to the node (for a Seller) and from the node (for a Buyer). The virtual market system guarantees these delivery costs directly or secures an acceptable third party guarantee. In this way all buyers and sellers are assured a fixed delivery cost to the node and can plan their purchases and sales based on this location.

In accordance with the logistics optimization system, prior to delivery and subsequent to the final trading date of a specific contract, VCS is utilized to reorder delivery of contracts to minimize the total delivery costs associated with all outstanding contracts being delivered. This portfolio approach to optimizing logistics of delivery allows the virtual market system guarantee fixed delivery costs to Sellers and Buyers which are significantly below delivery costs available to a single participant in a one-to-one transaction.

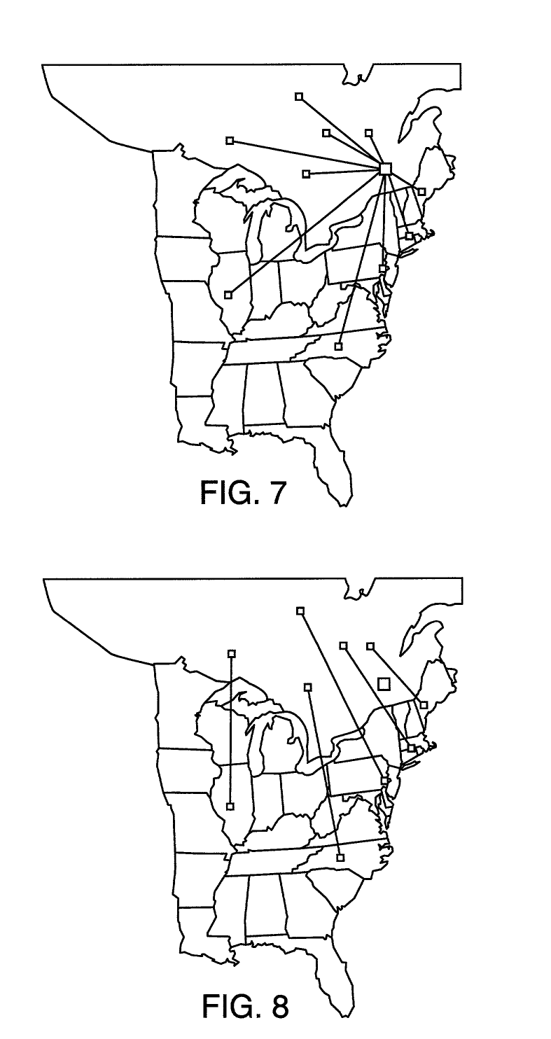

Reference is next made to FIG. 8 wherein an optimized delivery logistics system reduces overall shipping costs. As seen in FIG. 7 there is a pairing sellers and buyer which creates a minimization of delivery cost on a portfolio basis. The effect of this is that the guaranteed shipping cost built into the standardized contract can be reduced from that which would otherwise be required.

In addition, the invention is directed to a receivables funding system developed as an additional ancillary service. The receivables funding system allows sellers of products traded under the risk transfer conduit system to receive immediate payment for the sale of products for delivery at a future date. This is enabled by the financial planning and securitization of the process established by the risk transfer conduit system. It is a direct outgrowth of the risk transfer conduit system and the standardized contract system.

Utilizing the receivables funding system, the virtual market system is able to extend the time period for the funding of discounted receivables effectively to the date of sale of a forward contract. The virtual market system can forward funds to any seller participating in the trading of its standardized contracts on the date of sale of such contract, without regard to the identity of the Seller or Buyer or the actual delivery date designated in the forward contract. The virtual market funding conduit system provides a number of unique functions. It provides for excess risk calculations, additional coverage calculations, discount calculations based on virtual market system algorithms and funding of receivables for sellers.

The virtual funding conduit calculates the amount of excess risk (the “Excess Risk”) not covered by the system's Counter-party risk assurance products. This excess risk is the risk that the Pool Cap will be exceeded in any given Predefined Pool of risk.

The virtual funding conduit calculates the costs of obtaining additional insurance of a portion of the excess risks adequate to maintain the system's credit rating. This insurance will be obtained, as required, in the capital, insurance and reinsurance markets as part of the ongoing management of the virtual market system's risk portfolio.

The virtual funding conduit provides quotes of discount rates to Sellers. These rates will be calculated based on algorithms which will take into consideration funding costs based on the virtual market system's credit rating, the term of the forward contract and the all-in costs of additional credit coverage related to the potential funding.

The virtual funding conduit allows Sellers to opt to receive funds for forward sales, discounted at the quoted rate. If a Seller opts to receive such funding, the virtual funding conduit funds through the capital markets (at the virtual market system's rating rather than that of the seller), and obtains additional insurance in an amount commensurate with the Excess Risk associated with the funding amount. In addition, the market participant's risk exposure limit will reflect utilization by the seller of risk coverage for a percentage of the amount of the receivables funded.

In connection with the risk conduit transfer system a key element of standardization is the uniformity of risk among counterparties. The traditional methods of (a) collateral requirements calculated daily for each member of an exchange; and (b) trade credit insurance or letters of credit used in non-exchange trade are (x) costly compared with alternatives unavailable in today's marketplace and/or (y) inadequate, in the case of collateral systems, for many products. A database system that tracks aggregate net exchange-wide risk, (which is much less than the sum of the risk applicable to each participant because of internal netting of risks) so that sophisticated credit insurance and credit derivatives can be used in guaranteeing and insuring counterparty risk across an entire exchange is needed to achieve the desired liquidity. The use of such credit insurance places the insurance provider in the same economic position as each counterparty. As such, the insurance provider can then offer to the marketplace guaranteed delivery logistics. This is because the insurance provider, because of its economic position, can optimize delivery logistics across the entire pool of marketplace participants, lowering risks and costs. Further, since the insurance provider has guaranteed payment obligations by buyers, it can offer to the sellers unique funding of this obligation. The insurance provider can treat the buyer obligation as a receivable, even through conditions precedent do not exist for the payment obligation. Since the insurance provider guarantees payment and performance of the condition precedent, it can loan to the seller against the future receivable at the contract date.

It will thus be seen that the objects set forth above, among those made apparent in the preceding description, are efficiently obtained and, since certain changes may be made in the above constructions without departing from the spirit and scope of the invention, it is intended that all matter contained in the above description or shown in the accompanying drawings shall be interpreted as illustrative, and not in a limiting sense.

It is also to be understood that the following claims are intended to cover all of the generic and specific features of the invention, herein described and all statements of the scope of the invention which, as a matter of language, might be said to fall therebetween.

What is claimed is:

1. A method for managing, on a pooled basis, the credit risk coverage of contract performance by contracting parties, comprising:
for each contracting party, establishing an aggregate maximum credit risk coverage for all contracts by that contracting party;
defining pools into which contracts from various contracting parties may be aggregated and defining a credit risk coverage limit for each of the pools;
when a contract is entered into, calculating the credit risk coverage associated with that contract for each contracting party and determining whether that credit risk coverage plus the risk coverage associated with all other existing contracts of that contracting party are within the maximum credit risk coverage for that contracting party; and
using the determination, deciding whether to accept the contract in the pool.

2. The method of claim 1, wherein the credit risk coverage is calculated as the difference between a contract's price and a fixed price.

3. The method of claim 1, wherein the credit risk coverage associated with a contract is calculated based on a percentage of the sale price to sellers and a percentage of the purchase price to buyers.

4. The method of claim 1, further comprising insuring counterparty risk for each contract in at least one of the pools.

5. The method of claim 1, further comprising updating the aggregate credit risk coverage on a periodic basis.

6. The method of claim 1, further comprising netting out contracts for a contracting party having the same quantity, delivery period and delivery location.

7. The method of claim 1, wherein the pools are established by delivery terms of the products or services.

8. The method of claim 1, wherein the pools are established by place of delivery of the products or services.

9. The method of claim 1, wherein the pools are established by time of delivery of the products or services.

10. The method of claim 1, further comprising defining the credit risk coverage limit for the pool as a percentage of the total risk of all the contracts in the pool.

11. The method of claim 1, further comprising establishing the credit risk coverage limit for at least one of the pools based on the concentration of exposure by the parties in the pool.

12. The method of claim 1, further comprising defining periodically the credit risk coverage limit for at least one of the pools based on the volume of contracts the pool.

13. The method of claim 4, further comprising limiting aggregate insurance claims payable for each pool to the credit risk coverage limit for each pool.

14. The method of claim 4, further comprising syndicating at least a portion of the insured counter-party risk in at least one of the pools.

15. The method of claim 1, wherein the contracts are for the delivery of electrical energy.

16. The method of claim 15, wherein the credit risk coverage is calculated as the difference between a contract's price and a fixed price.

17. The method of claim 15, wherein the credit risk coverage associated with a contract is calculated based on a percentage of the sale price to sellers and a percentage of the purchase price to buyers.

18. The method of claim 15, further comprising insuring counter-party risk for each contract in at least one of the pools.

19. The method of claim 15, further comprising updating the aggregate credit risk coverage on a periodic basis.

20. The method of claim 15, further comprising netting out contracts for a contracting party having the same quantity, delivery period and delivery location.

21. The method of claim 15, wherein the pools are established by delivery terms of the products or services.

22. The method of claim 15, wherein the pools are established by place of delivery of the products or services.

23. The method of claim 15, wherein the pools are established by time of delivery of the products or services.

24. The method of claim 15, further comprising defining the credit risk coverage limit for the pool as a percentage of the total risk of all the contracts in the pool.

25. The method of claim 15, further comprising establishing the credit risk coverage limit for at least one of the pools based on the concentration of exposure by the parties in the pool.

26. The method of claim 15, further comprising defining periodically the credit risk coverage limit for at least one of the pools based on the volume of contracts in the pool.

27. The method of claim 18, further comprising limiting aggregate insurance claims payable for each pool to the credit risk coverage limit for each pool.

28. The method of claim 18, further comprising syndicating at least a portion of the insured counter-party risk in at least one of the pools.

29. A delivery optimization system for trading a plurality of contracts for the purchase and sale of a product or service entered into between purchasers and sellers having a contract price, delivery period and delivery node traded on an electronic marketplace, virtual marketplace or established commodity exchange, comprising:
recording the actual source and delivery locations of the seller and purchaser holders of the contracts,
grouping contracts by product, delivery node and delivery date; and
matching buyers with sellers of contracts, prior to the time of delivery to reduce overall shipping cost.

30. The delivery optimization system of claim 29, wherein the matching is done when the contracts are no longer transferrable.

31. The delivery optimization system of claim 30, further comprising pre-determining a shipping price for each buyer and seller.

32. A trading system for products and services, comprising:
a contract for a specified product or service including quantity, quality specification, delivery location and delivery period;
a market participant qualification mechanism which establishes a credit risk coverage limit for each approved market participant;
a counter-party risk assurance system which provides each market participant with a specified degree of protection against counter-party risks in connection with purchase and sale contracts entered into by each market participant;
at least one trading mechanism for creating a market in contracts for the purchase and sale of one or more products and services by market participants; and
an administrative system for tracking the trading mechanism, counter-party risk assurance system, market participants and paired contracts for the purchase and sale of a product or service.

33. The trading system of claim 32, further comprising a receivables funding system for paying sellers receivables prior to the delivery date of a sale contract.

34. The trading system of claim 33, wherein a percentage of the receivables paid to a seller is deducted from the seller's aggregate maximum credit risk coverage until delivery is effected.

35. The trading system of claim 33, wherein the buyer counterparty risk of the contract associated with the receivables paid to a seller is insured in an additional amount.

36. The trading system of claim 35, wherein the additional amount is calculated taking into account a pool limit.
